(19) United States
(12) Patent Application Publication
(10) Pub. No.: US 2024/0402335 A1
(43) Pub. Date: Dec. 5, 2024

(54) METHOD FOR DETERMINING OCCUPANCY INSIDE A MOTOR VEHICLE

(71) Applicant: VALEO COMFORT AND DRIVING ASSISTANCE, Créteil (FR)

(72) Inventors: Liangbin Xiang, Creteil (FR); Tarek Kasmieh, Creteil (FR)

(73) Assignee: VALEO COMFORT AND DRIVING ASSISTANCE, Créteil (FR)

(21) Appl. No.: 18/690,741

(22) PCT Filed: Sep. 13, 2022
(86) PCT No.: PCT/EP2022/075437

§ 371 Date: Mar. 11, 2024

(30) Foreign Application Priority Data
Sep. 16, 2021 (FR) 2109755

(51) Int. Cl. G01S 15/04; B60R 22/48; G01C 19/72; G01P 15/09; G01P 15/18

(52) U.S. Cl. CPC G01S 15/04; G01C 19/72; G01P 15/09; G01P 15/18; B60R 22/48; B60R 2022/4808

(57) ABSTRACT

The present invention relates to a method for determining occupancy inside a motor vehicle using a presence sensor. The method includes periodically determining the occupancy and determining a value representative of a quantity of vibration of the vehicle. The method also includes suspending the periodic determination of the occupancy. The suspension is triggered on the basis of the value representative of the quantity of vibration.

### TECHNICAL FIELD OF THE INVENTION

The present invention relates in a general way to the detection of persons inside a vehicle.

More particularly, it relates to a method for determining occupancy inside a motor vehicle.

The invention may be applied in a particularly advantageous manner in warning applications relating to the presence of forgotten children or the wearing of safety belts.

It also relates to a system implementing such a method.

### PRIOR ART

Presence detection systems using radar are increasingly integrated into motor vehicles. The use of radar is a promising alternative, since it is less costly to implement than conventional techniques based on weight sensors integrated into every seat of the vehicle.

Presence detection may be used, for example, to provide a warning of a child forgotten in a locked vehicle, or to remind a passenger to lock his safety belt.

In addition to its movement due to driving, the vehicle is subjected to vibration caused by external factors. This may occur when the vehicle is stationary, for example because of a flow of air, whether natural or created by another vehicle passing close by, or during repair or washing. It may also occur in a driving situation, for example as a result of an irregularity in the road or the movement of a passenger inside the vehicle.

These vibrations may interfere with the operation of the radar, for example by causing the movement of objects such as the seats that are normally fixed. These vibrations may inappropriately cause the false detection of persons.

Thus there is an evident need to make radar presence detection systems more robust to the vibrations of the vehicle.

### PRESENTATION OF THE INVENTION

In this context, according to the invention, a method is proposed for determining occupancy inside a motor vehicle, using a presence sensor, the method comprising the following steps:
periodically determining the occupancy;
determining a value representative of a quantity of vibration of the vehicle;
suspending the periodic determination of the occupancy, the suspension being triggered on the basis of the value representative of a quantity of vibration.

Thus, as a result of the invention, the vibrations to which the vehicle is subjected are quantified by means of the value representative of a quantity of vibration of the vehicle. By suspending the presence detection on the basis of this quantification, false detections due to vibrations can advantageously be eliminated. In practice, when the vibrations are too great, presence detection is suspended because it may generate false detections.

Remarkably, the suspension of the detection during a vibration has little effect on the functionality of the presence detection system, because it only creates a few moments' delay in any warning, concerning a forgotten child or seatbelt for example. On the other hand, it can avoid false detections, which are usually accompanied by annoying sound signals.

Other advantageous and non-limiting characteristics of the method for determining occupancy according to the invention, considered individually or in any technically possible combination, are as follows:
during the suspension, the occupancy is considered to be identical to the last occupancy determined before the suspension;
the suspension of the determination is triggered when the value representative of a quantity of vibration exceeds a first predetermined threshold value, or when a variation of the value representative of a quantity of vibration exceeds a second predetermined threshold;
the method further comprises a step of restarting the periodic determination of the occupancy, the restart being triggered on the basis of the value representative of a quantity of vibration;
the restarting step comprises a substep of reinitializing the presence sensor;
when the restarting step is triggered, the occupancy is initially determined as the last occupancy determined before the suspension;
the restart of the periodic determination is triggered when the value representative of a quantity of vibration falls below a third predetermined threshold value, or when a variation of the value representative of a quantity of vibration falls below a fourth predetermined threshold value;
the periodic determination of the occupancy consists in repeating said determination at a regular time interval;
the method further comprises a step of sending a signal on the basis of the state of presence, the signal indicating that an occupant is present in the stationary, locked vehicle, or that an occupant needs to put his safety belt on, or that an airbag needs to be inactivated;
the occupancy is determined for at least one of the seats of the vehicle, and the occupancy comprises an occupied state, in which an occupant is sitting on said seat, and a vacant state, in which said seat is unoccupied;
the value representative of a quantity of vibration is calculated as a weighted sum of the acceleration of the vehicle along a first axis and the acceleration of the vehicle along a second axis, different from the first axis;
weighting coefficients of said sum are chosen on the basis of at least one of the following causes of the vibration of the vehicle: a flow of air; a movement of the vehicle during maintenance or repair; an external person pushing the vehicle; the passing of the vehicle through a washing system; an imperfection of the roadway on which the vehicle is running; an occupant moving inside the vehicle.

The invention also proposes a system for determining occupancy inside a motor vehicle, comprising:
a presence sensor adapted for periodically determining the occupancy;
a vibration sensor adapted for determining a value representative of a quantity of vibration of the vehicle;
a computer connected to the presence sensor and to the vibration sensor, and programmed to suspend the periodic determination of the occupancy on the basis of the value representative of a quantity of vibration;

Other advantageous and non-limiting characteristics of the system for determining occupancy according to the invention, considered individually or in any technically possible combination, are as follows:
the vibration sensor is included on an electronic card which also includes the presence sensor;
the vibration sensor is included in, and used by, another system of the vehicle.

Of course, the different features, variants and embodiments of the invention may be associated with one another in various combinations insofar as they are not incompatible or mutually exclusive.

### DETAILED DESCRIPTION OF THE INVENTION

The following description with reference to the appended drawings, which are given by way of non-limiting examples, will give a good understanding of what constitutes the invention and how it can be implemented.

In the appended drawings:

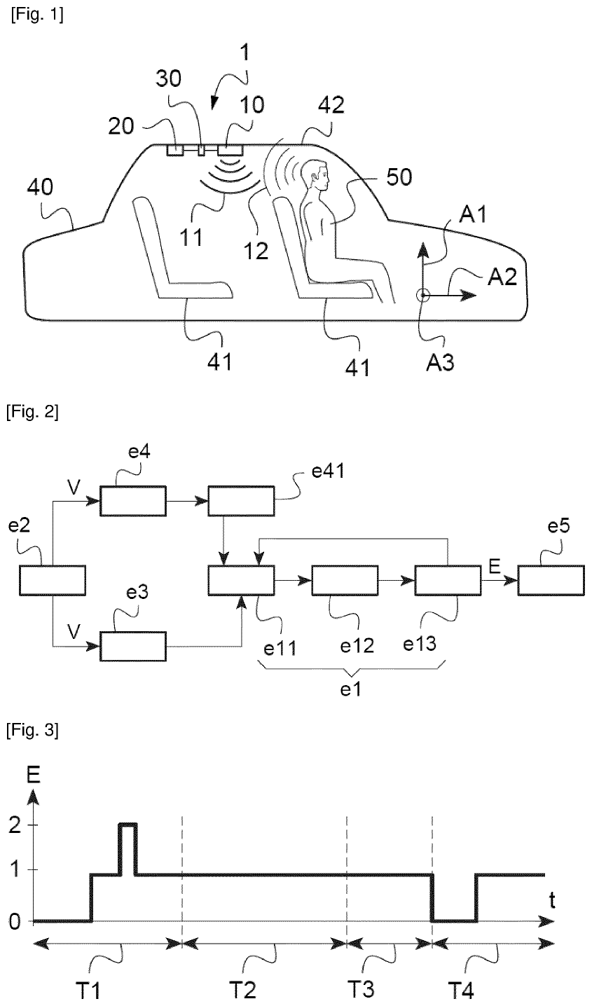

FIG. 1 is a schematic view, in section, of a vehicle incorporating the system for determining occupancy according to the invention.

FIG. 2 is a block diagram of a sequence of steps for implementing the method of determining occupancy according to the invention.

FIG. 3 is a graph representing a temporal change in occupancy which is determined using the method of FIG. 2.

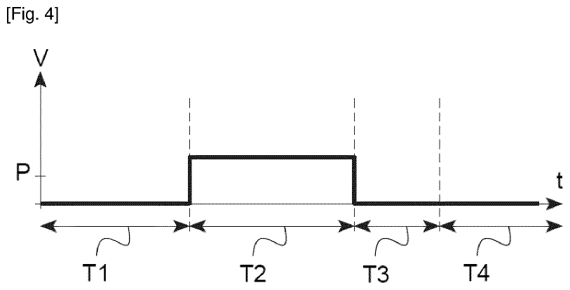

FIG. 4 is a graph representing a temporal change, concomitant with the temporal change in occupancy of FIG. 3, of a value representative of a quantity of vibration which is determined according to the method of FIG. 2.

FIG. 1 shows a system 1 for determining the occupancy E of an occupant 50 inside a vehicle 40, in this case a motor vehicle, according to the invention. The system 1 comprises:
a presence sensor 10;
a vibration sensor 20; and
a computer 30 connected to the presence sensor 10 and to the vibration sensor 20.

The presence sensor 10 is adapted for determining the presence of an occupant 50 inside the vehicle 40. In this case, the presence sensor 10 is more generally adapted for determining, for each seat 41 of the vehicle 40, the presence of a person, that is to say the presence of the driver or a passenger. A single occupant 50, in this case the driver, is shown in FIG. 1. As well as being able to determine presence on the seats 41, the presence sensor 10 also covers the trunk and the areas adjacent to the seats, typically the foot space located under the seats 41.

By placing the presence sensor 10 in a central area of the vehicle 40, in this case in the centre of the roof 42 of the vehicle 40 as shown in FIG. 1, the presence sensor 10 is then advantageously able to cover all the seats 41 of the vehicle 40.

The presence sensor 10 may be any instrument enabling the presence of an occupant 50 inside the vehicle 4 to be determined. The presence sensor 10 may consist of a single sensitive element or a network of sensitive elements distributed across the vehicle 40.

The presence sensor 10 may, for example, be a camera or a camera network, or even an ultrasonic sensor or a network of ultrasonic sensors.

In this case, the presence sensor 10 is a device for transmitting and receiving waves. These waves are, for example, sound waves.

In this case, these waves are electromagnetic waves 11. The transmitter/receiver device in this case comprises an antenna (not shown) designed to transmit the electromagnetic waves 11 and at least one receiver (not shown) designed to receive reflected electromagnetic waves 12 after the reflection of the electromagnetic waves 11, and particularly after reflection from an occupant 50.

The transmitter/receiver device in this case is more specifically a radar (radio detection and ranging) using millimeter electromagnetic waves. The radar is, for example, a continuous-wave Doppler radar. The radar is, for example, of the same type as a radar used in the vehicle 40 for driving assistance and/or obstacle detection.

The computer 30 comprises at least one memory and at least one processor. The computer 30 may, for example, be the electronic control unit (ECU) of the vehicle 40. The computer 30 may also be a computer dedicated to the system 1. Instructions for determining the occupancy E are recorded in the memory and are implemented by the processor. When they are implemented, these instructions enable the method described below to be executed.

In particular, the computer 30 is programmed to control the transmitter/receiver device, notably for controlling the transmission of the electromagnetic waves 11.

By analyzing the reflected electromagnetic wave 12 captured by the sensor of the transmitter/receiver device, the computer 30 determines, in this case for each seat 41, the occupancy E, indicating whether the seat 41 is occupied or vacant. Occupancy E may also be determined for the trunk of the vehicle 40, and an indication may be given as to whether an occupant 50 is present in the trunk.

For each seat 41, and for its vicinity in this case, the occupancy E comprises an occupied state, in which an occupant 50 is sitting on the seat 41 or located in the immediate proximity of the seat 41, for example slightly above the seat 41, and a vacant state, in which no person is sitting on the seat 41 or located in the proximity of the seat 41. The vacant state therefore corresponds to the occupancy E in which the seat 41 is free.

The vibration sensor 20, for its part, enables the acceleration of the vehicle 40 to be measured along at least one axis. As for the presence sensor 10, the vibration sensor 20 may also comprise one or more elements distributed in the vehicle. Here, one element of the vibration sensor 20 is located in the proximity of each sensitive element of the presence sensor 10, preferably on the same electronic circuit card as this sensitive element.

The vibration sensor 20 may, for example, be a fiber-optic gyroscope.

Here, the vibration sensor 20 is more specifically an accelerometer.

The accelerometer in this case is a microelectromechanical system (better known under the acronym MEMS). In a variant, the accelerometer could be a piezoelectric accelerometer.

The accelerometer in this case is fixed relative to the vehicle 40, particularly relative to its bodywork. In the example shown in FIG. 1, the accelerometer is thus located on the roof 42 of the vehicle 40. Here, although it is shown separately from the transmitter/receiver device in FIG. 1, the accelerometer 30 is included on an electronic circuit card which also includes the transmitter/receiver device. In a variant, the accelerometer is included in and used by another system of the vehicle, for example a wheel anti-lock system or an airbag control system. The accelerometer is, for example, located in the instrument panel of the vehicle.

Here, the accelerometer enables the acceleration of the vehicle 40 to be measured along three orthogonal axes. As shown in FIG. 1, these three axes are, for example, the vertical direction A1 (orthogonal to the road), the forward-reverse direction A2 of the vehicle 40, and the left-right direction A3 of the vehicle 40.

The accelerometer is thus adapted for determining a value representative of an amount of vibration of the vehicle 40. This value representative of an amount of vibration of the vehicle 40, referred to below as the vibration value V, is for example expressed in milli-g, that is to say in thousandths of g, where the value of g is approximately 9.8 m/s².

Here, the vibration value V is representative of an intensity of a vibration to which the vehicle 40 is subjected, that is to say representative of the amplitude and/or the velocity of a movement of the vehicle 40 about an equilibrium position which is, for example, that of the vehicle 40 stationary and immobile, or of the vehicle 40 advancing at constant velocity. In practice, the movement of the vehicle 40 about its equilibrium position is a movement of a few millimetres or a few centimetres.

The vibration undergone by the vehicle 40 and quantified using the vibration value V is generated here by an external event causing the vehicle 40 to move. In this case, “external” is taken to mean an event that is not due to the vehicle 40 itself, for example one that is not due to the movement of the vehicle by its engine. Examples of an external event generating the vibration 40 are:
a flow of air;
a movement of the vehicle in the course of maintenance or repair;
an external person pushing the vehicle 40;
passage of the vehicle through a washing system;
an imperfection in the road surface on which the vehicle is running;
an occupant moving inside the vehicle.

In the system 1, the computer 30 is also programmed to control the accelerometer, notably for the purpose of determining the vibration value V on the basis of output signals of the accelerometer.

In practice, the system 1 determines the occupancy E by detecting a shift or movement of an occupant 50, including respiration or heartbeats. This detection is precise because of the use of short electromagnetic waves, but is sensitive to the vibrations of the vehicle 40.

To prevent false detections, the computer 30 is programmed to implement a method of determining the occupancy E in which the determination of the occupancy E may be suspended, on the basis of the vibrations to which the vehicle 40 is subjected. The method according to the invention is illustrated in FIG. 2.

As is shown in FIG. 2, the method comprises the following main steps:
a step e1 of periodically determining the occupancy E, using the transmitter/receiver device;
a step e2 of determining the vibration value V;
a step e3 of suspending the periodic determination of the occupancy E, the suspension being triggered on the basis of the vibration value V.

The term “periodic” here signifies “repeatedly”. It also signifies “automatically”. More specifically, the determination of the occupancy E is here repeated at a regular time interval, for example every ten seconds. The regular time interval being, for example, less than one minute. Preferably, the regular time interval is between three and five seconds. The regular time interval may be adapted on the basis of the movement of the occupant 50 that is to be detected; for example, it may be five seconds before a respiratory movement and four seconds for head movements.

Advantageously, the computer 30 may be programmed to adapt the frequency of repetition of the periodic determination on the basis of the use made of the occupancy E, namely the indication of a forgotten child or of the wearing of a safety belt, etc.

In a variant, periodic determination of the occupancy could mean that the occupancy is determined at short but irregular time intervals; on the other hand, however, these time intervals could follow a predetermined repetition schedule.

The vibration value V is determined by means of the accelerometer. Here, the vibration value V is also determined in a periodic manner. For example, the vibration value V is determined at the same frequency as the occupancy E. The vibration value V may also be determined at a frequency other than that used for the occupancy E. Preferably, the determination of the vibration value V is repeated at a regular time interval of less than one minute. Here, for example, the determination of the vibration value V is repeated every 50 milliseconds

Here, the suspension consists in interrupting the periodic determination of the occupancy E. In other words, starting from the suspension, the occupancy E is no longer determined until the restart step e4.

The suspension of the periodic determination of the occupancy E is triggered on the basis of the vibration value V. Thus, if the latter is, for example, too high or too rapidly increasing, the periodic determination of the occupancy E is suspended in order to avoid false presence detections. A false presence detection here signifies the determination of an occupancy E as an occupied state when the seat 41 and/or its vicinity (the space at foot level, for example) is unoccupied.

Suspending the determination of the occupancy E is a robust and easily implemented means of avoiding false detections. Furthermore, suspending the determination of the occupancy E enables the computer 30 to act with a very short reaction time as soon as a vibration is measured.

The aforementioned main steps can now be described in detail.

As shown in FIG. 2, the step e1 of periodic determination of the occupancy E comprises the following substeps:
a substep e11 of transmitting the electromagnetic wave 11 via the antenna;
a substep e12 of receiving the reflected electromagnetic wave 12 via the sensor,
a substep e13 of analyzing the reflected electromagnetic wave 12, by means of the computer 30, to determine the occupancy E.

Here, as shown schematically in FIG. 2, after the occupancy E has been determined by a first cycle of transmission, reception and analysis, the occupancy E can be re-determined by a new cycle of transmission, reception and analysis.

Here, therefore, the periodic determination of the occupancy E means, in particular, that the substep e11 of transmitting the electromagnetic wave 11 is executed periodically. The other two substeps, of reception e12 and analysis e13, are then included in the chain, again in a periodic manner.

In a variant, the transmission and reception substeps are repeated periodically at a higher frequency than the determination of the occupancy. For example, a plurality of reflected electromagnetic waves are analyzed to determine occupancy.

In FIG. 3, the step e1 of periodically determining the occupancy E is executed throughout a first repetition period T1 and a second repetition period T4.

As shown in FIG. 3, the occupancy E may vary between the occupied state, to which the computer 30 assigns the numeric value 1, and the vacant state, to which the computer 30 assigns the numeric value 0. Here, the occupancy E also comprises a blocked state in which the transmitter/receiver device is obstructed, by a hand for example, making the determination of the occupancy E impossible, to which state the computer 30 assigns the numeric value 2.

The repetition of the determination of the occupancy E is illustrated in FIG. 2 by a continuous variation of the numeric value assigned to the occupancy E during the first repetition period T1 and the second repetition period T4.

The vibration value V is calculated by the computer 30 as a weighted sum of the acceleration of the vehicle 40 along at least two different axes. Here, the vibration value V is calculated as a weighted sum of the acceleration of the vehicle 40 in the vertical direction A1, the forward-reverse direction A2 and the left-right direction A3. Each direction A1, A2, A3 is then associated with a weighting coefficient. Evidently, the vibration value V may be the result of a vibration in a single axis, and may be sufficient to suspend the periodic determination.

The weighting of this sum may be adapted on the basis of the external event that generates the vibration of the vehicle 40. Thus, for example, when the vehicle 40 is parallel parked along the road, it may vibrate laterally due to an air flow generated by another vehicle. In this case, a high weighting coefficient relative to the other directions, and notably relative to the forward-reverse direction A2, may be applied by the computer 30 to the acceleration in the left-right direction A3, thereby effectively limiting false detections due to such an external event.

The weighting of this sum may be adapted on the basis of the use made of the occupancy E, such as warning of a forgotten child, indicating the wearing of a safety belt, etc. Here, the weighting of the sum is predetermined, that is to say chosen before the implementation of the method, so as to detect the smallest vibrations associated with the aforesaid external events that may cause false detections.

When determined, the vibration value V enables the computer 30 to trigger the suspension of the determination of the occupancy E.

For this purpose, in a first variant embodiment, the computer 30 compares the vibration value V with a first predetermined threshold value P. If the vibration value V is greater than the first predetermined threshold value P, or strictly greater than the latter for example, the computer 30 suspends the periodic determination of the occupancy E.

Thus, in the example shown in FIG. 4, the instant when the vibration value V becomes greater than the first predetermined threshold value P marks the change from the first repetition period T1, in which the determination of the occupancy E is periodic, to a suspension period T2 in which the determination of the occupancy E is suspended.

Preferably, in a second variant embodiment, the computer 30 compares a temporal variation of the vibration value V, that is to say a time derivative of the vibration value V, with a second predetermined threshold value. If the derivative of the vibration value V is greater than the second predetermined threshold value, for example strictly greater, the computer 30 suspends the periodic determination of the occupancy E. Here, the frequency of determination of the vibration value V is high, at less than two seconds for example, so that a precise derivative can be calculated. The frequency of determination of the vibration value V is notably high during the first iterations, so that a calculation log can be created.

The first predetermined threshold value P or the second threshold value may be adjusted to limit the false detections to a greater or lesser degree. The first predetermined threshold value P is, for example, between 0.3 and 0.5 milli-g. The second predetermined threshold value is, for example, a variation of 2 milli-g for an interval of 60 milliseconds.

Here, the curves of vibration and temporal variation of vibration are acquired in test sequences for the various aforesaid external events. The first threshold value P and the second threshold value may then be determined from these curves on the basis of the effect of the external events on the detection of the occupancy E.

Suspension may, for example, consist in interrupting the transmission of the electromagnetic wave 11, as shown in FIG. 2, or interrupting the analysis of the reflected electromagnetic wave 12.

Remarkably, during the suspension period T2, the occupancy E is considered to be equal to the last occupancy E determined before the suspension. In other words, the computer 30 retains in its memory the last occupancy E determined before the suspension. The last occupancy E is, for example, that determined in the transmission/reception/analysis cycle preceding the instant when the vibration value V becomes greater than the first predetermined threshold value P.

Thus, in the example illustrated in FIGS. 3 and 4, when the suspension is triggered, the occupancy E retains its last value acquired during the first repetition period T1, namely the numeric value 1 associated with the occupied state.

Retaining the last value of the occupancy E enables the functions of the vehicle 40 to continue to operate on the basis of the occupancy E when the latter is determined in stable conditions. Here, however, the occupancy value is not retained if the doors of the vehicle are subjected to opening and closing actions, because this probably indicates a change in the number of occupants of the vehicle 40.

In a variant, during the suspension period, the occupancy could be fixed automatically in one of the two states, for example “vacant” for the function of warning of a forgotten child.

Even when the determination of the occupancy E is suspended, step e2 of determining the vibration value V continues to be executed periodically. For example, the vibration value V continues to be determined throughout the time interval T2. In the illustrated example, the vibration value V remains constant, indicating that the vehicle 40 is vibrating at a constant intensity.

The suspension therefore consists in temporarily halting the periodic determination of the occupancy E for the duration of one vibration.

As shown in FIG. 2, the method here comprises the supplementary step e4 of restarting the periodic determination of the occupancy E. In the same way as for the suspension, the restart is triggered on the basis of the vibration value V. The restart consists in recommencing the determination of the occupancy E in a periodic manner.

Thus the restart enables the occupancy E to be determined when the vibration that triggered the suspension ceases, and therefore on the basis of a stable signal generated by the transmitter/receiver device.

For this purpose, in a similar manner to suspension, the restart of the periodic determination is, for example, triggered when the vibration value V becomes lower than a third predetermined threshold value. For example, this is the case in the example shown in FIG. 4. The third predetermined threshold value is, for example, equal to the first predetermined threshold value P.

Preferably, the restart of the periodic determination is, for example, triggered when the derivative of the vibration value V becomes lower than a fourth predetermined threshold value which is, for example, equal to the second predetermined threshold value.

As shown in FIG. 2, the restart step e4 here comprises a single step e41 of reinitializing the transmitter/receiver device.

The reinitialization here generates a wait period T3 corresponding to a complete transmission/reception/analysis cycle for the determination of the occupancy E. The reinitialization makes it possible to avoid determining the occupancy E on the basis of a radar signal considered to be corrupted due to a vibration during a transmission/reception/analysis cycle.

During the wait period T3, the occupancy E is again considered to be equal to the last occupancy E determined before the suspension. When the restart step e4 is triggered, the occupancy E is therefore initially determined, during a brief instant corresponding to the wait period T3, as the last occupancy E determined before the suspension.

Thus, in the example of FIG. 3, during the wait period T3, the computer 30 continues to treat the occupancy E as equal to the occupied state, which was the last occupancy E determined before the suspension.

After the wait period T3, the computer 30 restarts the periodic determination of the occupancy E. Here, immediately after the wait period T3 and before the first determination of the occupancy, the latter is initially indeterminate (a state not shown in the figures) and therefore does not trigger false detections.

In the example shown in FIG. 3, on completion of the reinitialization, that is to say at the start of the second repetition period T4, the occupancy E is initially determined as the vacant state. Thereafter, the occupancy E is determined as the occupied state, and its numeric value then changes from 0 to 1. The computer 30 restarts the periodic determination of the occupancy E throughout the second repetition period T4, until a new suspension for example.

Finally, as shown in FIG. 2, the method here comprises a step e5 of transmitting a signal based on the occupancy E. The signal is here a warning signal, for example an audible signal intended for an occupant 50 or for the holder of the keys of the vehicle 40.

The signal indicates, for example, that an occupant 50 is present in the stationary, locked vehicle, or that an occupant 50 needs to put his safety belt on. The signal may also be a signal of the inactivation of the airbag triggering for a certain type of occupant 50.

The present invention is in no way limited to the embodiments described and shown, but those skilled in the art will know how to add any variant in accordance with the invention thereto.

1. A method for determining occupancy inside a motor vehicle using a presence sensor,
the method comprising:
periodically determining the occupancy;
determining a value representative of a quantity of vibration of the vehicle;
wherein the method further comprises suspending the periodic determination of the occupancy,
wherein the suspension is triggered on the basis of the value representative of a quantity of vibration.

2. The method as claimed in claim 1,
wherein, during the suspension, the occupancy is considered to be equal to the last occupancy determined before the suspension.

3. The method as claimed in claim 1,
wherein the suspension of the determination is triggered when the value representative of a quantity of vibration becomes greater than a first predetermined threshold value or when a variation of the value representative of a quantity of vibration becomes greater than a second predetermined threshold value.

4. The method as claimed in claim 2, the method additionally comprising restarting the periodic determination of the occupancy,
wherein the restart is triggered on the basis of the value representative of a quantity of vibration.

5. The method as claimed in claim 4,
wherein the restart comprises reinitializing the presence sensor.

6. The method as claimed in claim 4,
wherein, when the restart is triggered, the occupancy is initially determined as the last occupancy determined before the suspension.

7. The method as claimed in claim 4,
wherein the restart of the periodic determination is triggered when the value representative of a quantity of vibration becomes lower than a third predetermined threshold value or when a variation of the value representative of a quantity of vibration becomes lower than a fourth predetermined threshold value.

8. The method as claimed in claim 1,
wherein the periodic determination of the occupancy consists in repeating the determination at a regular time interval.

9. The method as claimed in claim 1,
the method additionally comprising transmitting a signal on the basis of the occupancy,
wherein the signal indicates that an occupant is present in the stationary, locked vehicle, or that an occupant needs to put on his safety belt, or that an airbag needs to be inactivated.

10. The method as claimed in claim 1,
wherein the occupancy is determined for at least one of the seats of the vehicle, and
wherein the occupancy comprises an occupied state in which an occupant is sitting on the seat and a vacant state in which the seat is unoccupied.

11. The method as claimed in claim 1,
wherein the value representative of a quantity of vibration is calculated as a weighted sum of the acceleration of the vehicle along a first axis and the acceleration of the vehicle along a second axis different from the first axis.

12. The method as claimed in claim 11,
wherein weighting coefficients of the sum are chosen on the basis of at least one of the following causes of the vibration of the vehicle:
a flow of air;
a movement of the vehicle in the course of maintenance or repair;
an external person pushing the vehicle;
passage of the vehicle through a washing system;
an imperfection in the road surface on which the vehicle is running;
an occupant moving inside the vehicle.

13. A system for determining occupancy inside a motor vehicle, the system comprising:
a presence sensor adapted for periodically determining the occupancy;
a vibration sensor adapted for determining a value representative of a quantity of vibration of the vehicle;
a computer connected to the presence sensor and to the vibration sensor;
wherein the computer is programmed to suspend the periodic determination of the occupancy on the basis of the value representative of a quantity of vibration.

14. The system as claimed in claim 13,
wherein the vibration sensor is included on an electronic circuit card which also comprises the presence sensor.

15. The system as claimed in claim 13,
wherein the vibration sensor is included in, and used by, another system of the vehicle.
